(19) United States
(12) Patent Application Publication
(10) Pub. No.: US 2012/0095824 A1
(43) Pub. Date: Apr. 19, 2012

(54) LIFE-VERTISEMENTS

(75) Inventors: Tarun Bhatia, Simi Valley, CA (US); Darshan V. Kantak, Pasadena, CA (US)

(73) Assignee: Yahoo! Inc., Sunnyvale, CA (US)

(21) Appl. No.: 12/906,795

(22) Filed: Oct. 18, 2010

(51) Int. Cl. G06Q 30/00

(52) U.S. Cl. 705/14.41

(57) ABSTRACT

The present invention provides techniques for use of advertisements, including advertisements which may be termed “life-vertisements” or applitisements. Life-vertisements can include brand advertising advertisements for user-initiated use with or within software-based or online applications. User interaction with or usage of a life-vertisement may be tracked over time and multiple interactions, sometimes over evolving use or over multiple applications. The tracked information may be used in assessing performance of the life-vertisement, such as in assessing favorable branding value or brand engagement value associated with the life-vertisement or its usage.

### BACKGROUND

Online users are often not averse to certain types of advertisements, such as premium and useful advertisements, online. In fact, they often expect such advertisements to subsidize their free Web usage. However, to encourage usage and enhance effectiveness, advertisements need to be consistent with users' motivations, and not violate or degrade their overall experience. Furthermore, user activities, including content consumption, are shifting, from such things as search and selection of sites and articles, to activities such as interacting via applications within sites, on mobile and social platforms, for example.

There is always a need for more effective advertisements and advertising techniques.

### SUMMARY

Some embodiments of the invention provide systems and methods including techniques for use of advertisements, including advertisements which may be termed “life-vertisements”. Life-vertisements can include advertisements, such as in brand advertising, for user-initiated use with or within software-based or online applications. User interaction with or usage of a life-vertisement may be tracked over time, over use with one or multiple applications. The tracked information may be used in assessing performance of the life-vertisement, such as in assessing favorable branding value or brand engagement value associated with the life-vertisement or its usage, and in other ways.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

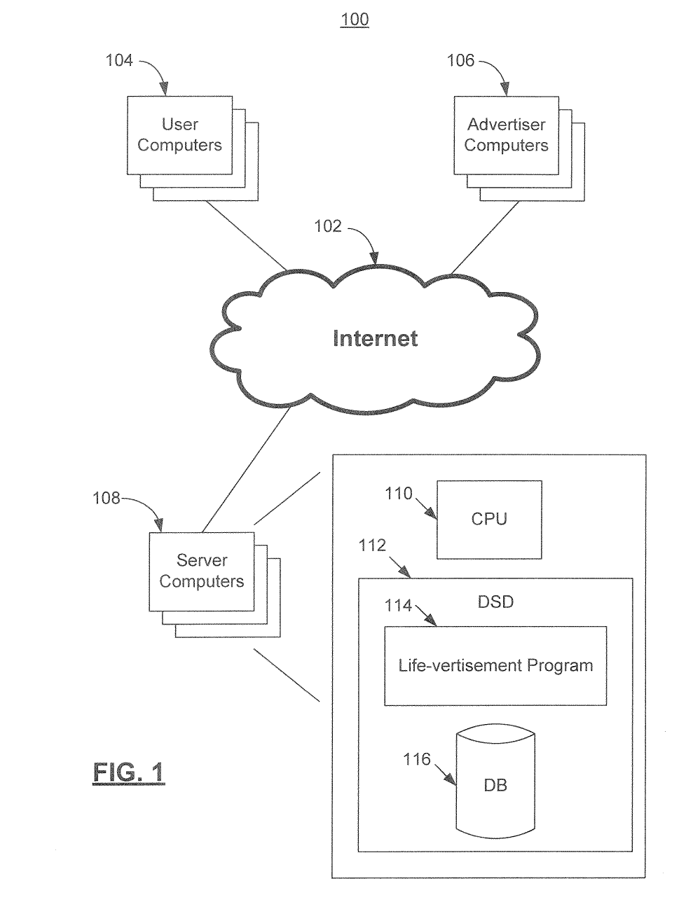

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Life-vertisement Program 114.

The Program 114 is intended to broadly include all programming, applications, algorithms, software and other and tools necessary to implement or facilitate methods and systems according to embodiments of the invention, including, among other things, techniques relating to life-vertisements. The elements of the Program 114 may exist on a single server computer or be distributed among multiple computers or devices.

Various monetization techniques or models may be used in connection with advertising, such as sponsored search advertising, including advertising associated with user search queries, and non-sponsored search advertising, including graphical or display advertising. In an action-based online advertising marketplace, advertisers may bid in connection with placement of advertisements, although many other factors may also be included in determining advertisement selection or ranking. Bids may be associated with amounts the advertisers pay for certain specified occurrences, such as for placed or clicked-on advertisements, for example.

Advertiser payment for online advertising may be divided between parties including one or more publishers or publisher networks, and one or more marketplace facilitators or providers, potentially among other parties. Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per lick or number of clicks, cost per action for some specified action, cost per conversion or purchase, or cost based on some combination of metrics, which can include online or offline metrics. In some embodiments of the invention, payment may be based on assessed favorable branding or brand engagement value, for example.

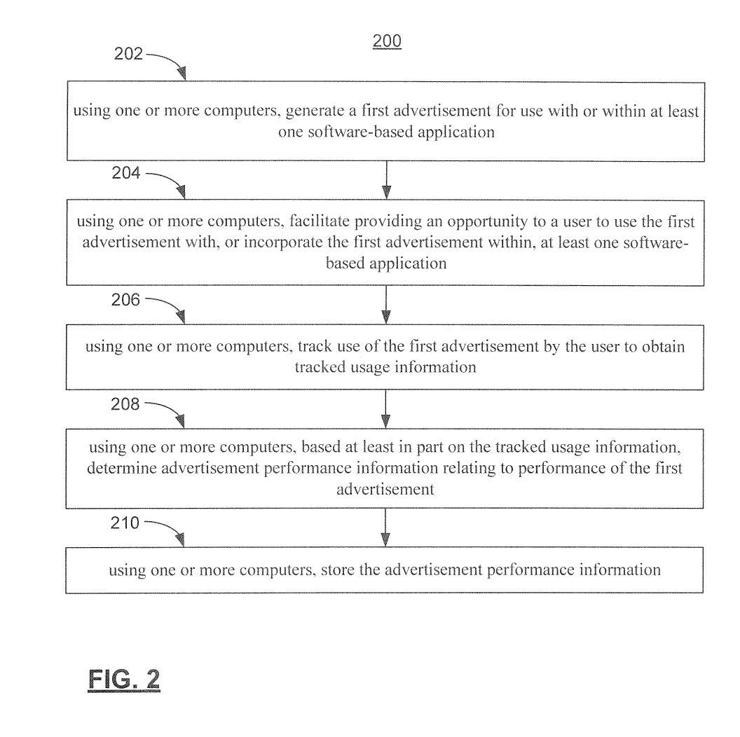

FIG. 2 is a flow diagram illustrating a method 200 according to one embodiment of the invention. At step 202, using one or more computers, a first advertisement, such as a life-vertisement, is generated for use with or within at least one software-based application.

At step 204, using one or more computers, the method 200 includes facilitating providing an opportunity to a user to use the first advertisement with, or incorporate the first advertisement within, at least one software-based application.

At step 206, using one or more computers, use is tracked of the first advertisement by the user to obtain tracked usage information.

At step 208, using one or more computers, based at least in part on the tracked usage information, advertisement performance information is determined relating to performance of the first advertisement.

At step 210, using one or more computers, the advertisement performance information is stored.

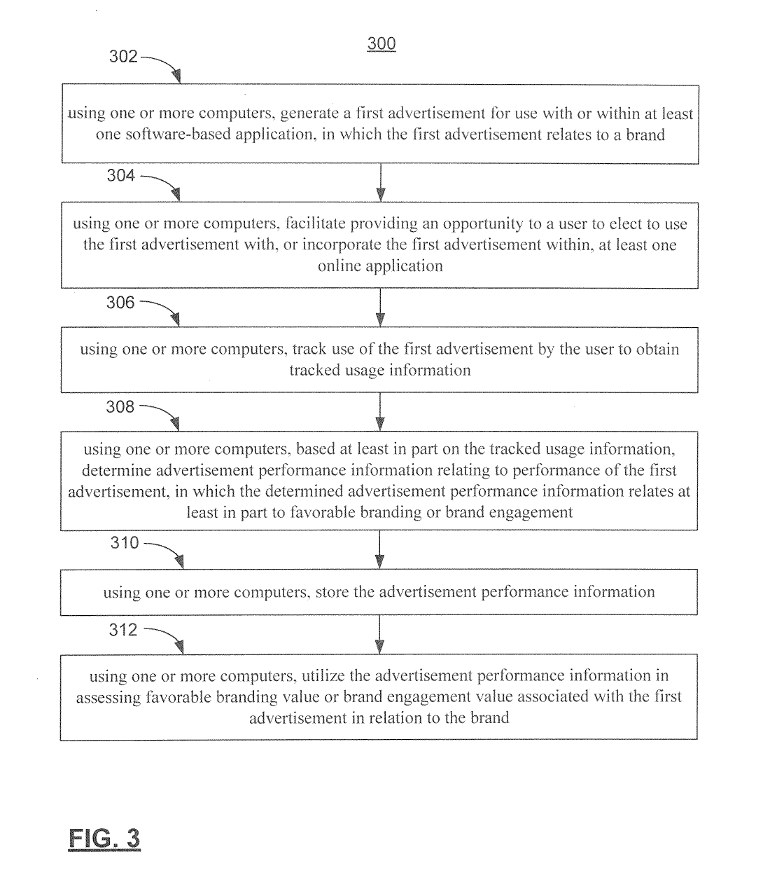

FIG. 3 is a flow diagram illustrating a method 300 according to one embodiment of the invention. At step 302, using one or more computers, a first advertisement is generated for use with or within at least one software-based application, in which the first advertisement relates to a brand.

At step 304, using one or more computers, the method 300 includes facilitating providing an opportunity to a user to elect to use the first advertisement with, or incorporate the first advertisement within, at least one online application.

At step 306, using one or more computers, use is tracked of the first advertisement by the user to obtain tracked usage information.

At step 308, using one or more computers, based at least in part on the tracked usage information, advertisement performance information is determined, relating to performance of the first advertisement, in which the determined advertisement performance information relates at least in part to favorable branding or brand engagement.

At step 310, using one or more computers, the advertisement performance information is stored.

At step 312, using one or more computers, the advertisement performance information is utilized in assessing favorable branding value or brand engagement value associated with the first advertisement in relation to the brand.

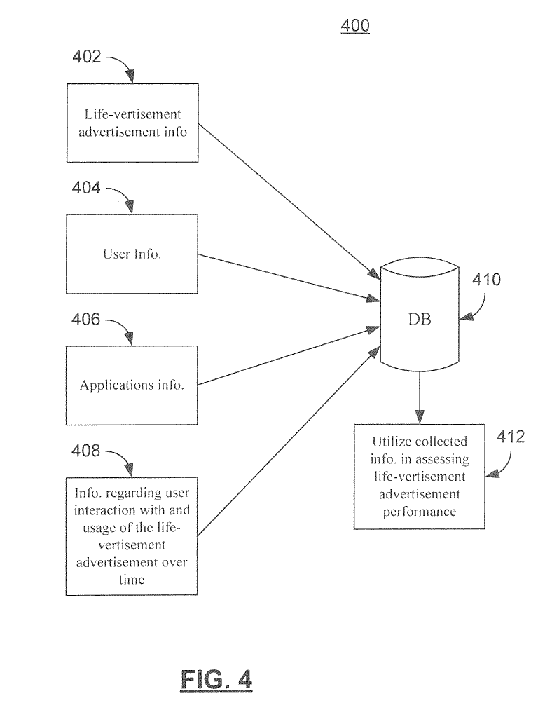

FIG. 4 is a block diagram 400 illustrating one embodiment of the invention. As depicted, various types of information is collected and stored in one or more databases 410. The collected information includes life-vertisement advertisement information 402, user information 404, applications in information 406, and information regarding user interaction with and usage of the life-vertisement (which can be or include an object) over time 408.

As represented by block 412, the collected information, as well as potentially other information, is used for, potentially among other things, assessing life-vertisement advertisement performance.

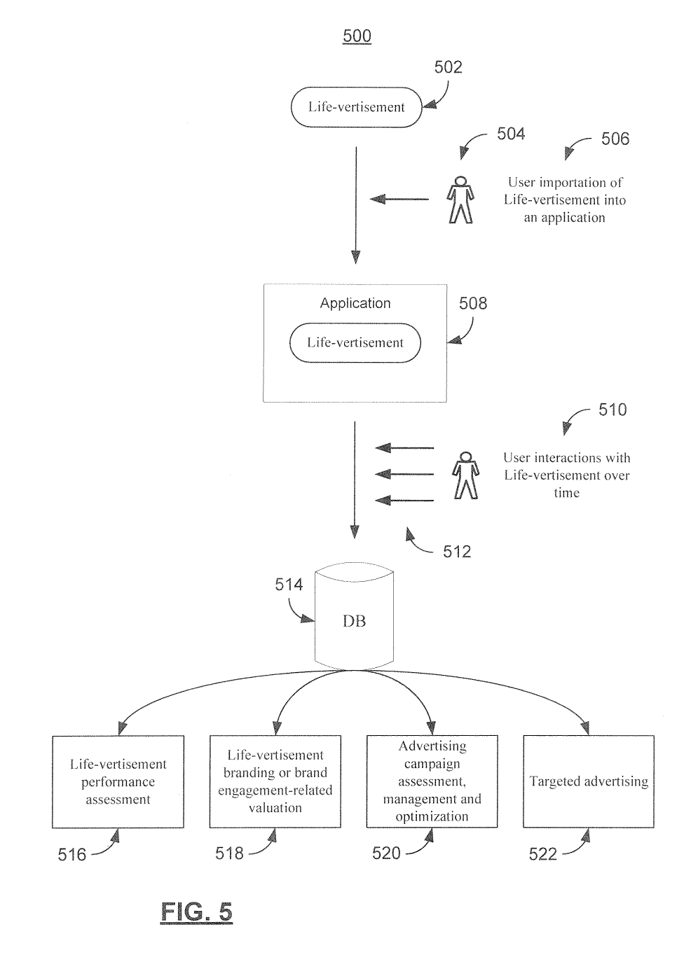

FIG. 5 is a block diagram 500 illustrating one embodiment of the invention. A life-vertisement is represented by oval 502. As further depicted, a user 504 imports 506 the life-vertisement 502 into an application 508 that the user uses. The user 504 proceeds to use and interact 510 with the application 508, and the life-vertisement 502, over time, which can include numerous interactions, as represented by arrows 512.

Various information, such as life-vertisement information, application information, user information, and user interaction information, is stored in one or more databases 514.

The stored information can be used in various ways and for various purposes. For example, life-vertisement advertisement performance assessment 516, life-vertisement branding or brand engagement-related valuation 518, advertising campaign assessment, management and optimization 520, and targeted advertising 522.

Some embodiments of the invention provide systems and methods including techniques for delivering online advertisements, such as life-vertisements, that are evolved, in that they can merge with content that users consume, specifically applications, for example. One motivation may be to collect brand engagement feedback on advertisements, beyond impression information, as a result of the delivered advertisement's prolonged utility and life cycle, within application contexts that users adopt, for example.

Brand advertisers often seek engagement and brand favorable response, even though they have continued to buy impressions, and even though not all impressions are alike and often differ in the level of engagement achieved with users. Some embodiments of the invention include a recognition that, for example, to provide meaningful performance feedback on campaign exposure, it may be necessary to move beyond reach, frequency, and impressions towards the extent of brand lift achieved and engagement delivered.

Some embodiments of life-vertisements, which may also be called applitisements, are in some ways similar to conventional advertisements, but are more evolved in that, for example, they may contain application objects that can be imported into an application context by the user. This user action may be deemed a special event that contributes to brand lift metrics. Beyond the impression, and the user importation of the object, the branded object may continue to enrich the user's experience within an application context. Every time it is used within the application, it may continue to generate statistics for the campaign's effectiveness for brand metrics, for example.

Some embodiments of the invention include a recognition that users surf the Web to, for example, gain knowledge, for entertainment, or for utility, such as to save time and money, and some embodiments of life-vertisements leverage this and enhance user experiences. Many possibilities are contemplated, and some examples are provided. For one example, in some embodiments, a life-vertisement can include an advertisement or advertisement unit containing a podcast for an introductory class or a book summary. As another example, a user may be allowed import a life-vertisement including virtual branded copy of a company's new sneaker for the user's avatar within a social virtual reality game.

As another example, life-vertisements may include other objects for use in virtual reality-based games or simulation, whether decorative or functional, which may be branded in any way, such as visibly, through associated audio or video, through causing visible or other forms of branding in other aspects of the application, etc. As another example, a retail company may allow a user to use a life-vertisement including a 10% coupon by using it with a coupon basket application, which application may or may not be created specifically for or to allow the use of life-vertisements.

In various embodiments, life-vertisements may be delivered directly to a user, such as, for example, from a related or larger advertisement, or may be acquired by a user such as, for example, at a visited Web site. In some embodiments, life-vertisements may need to be acquired by user action, acceptance, or both, while in other embodiments they may be delivered without user action or acceptance.

Many brand advertisers seek engagement with target audiences, but often continue to buy impressions or impression-based products. Some embodiments of the invention include a recognition that one way to provide engagement measurements is to float out application objects via advertisements online, and instrument the usage and utility patterns of the users thereafter. In some embodiments, for example, this may be achieved in part by tailoring advertisement creatives to incorporate application objects that can be imported into an application via a simple click, such as, for instance, getting a Nike hat for an avatar in a game. In this manner, in some embodiments, the advertisements become more consistent with applications that a user is actively engaged with, and converge on the experience within the application, thereby becoming more relevant for the user, more effective, and more likely to be adopted by the user. This in turn can generate feedback events that advances the measurable brand impact for the campaign, for example.

In some embodiments, advertisers can create special campaigns with life-vertisements, targeting specific application users. Life-vertisements may be self-delivered, or may be delivered or appear from an advertising unit impression. The life-vertisements may appear within a standard advertisement unit, but include the possibility or function of a user-initiated action to import the associated application object. In some embodiments, users are provided with choices within the import step, which could include surveys, etc., and the resulting input provides direct brand or product feedback to the advertiser, that could be used in many ways, including, for example, in classifying users, as market research information, as information regarding user preferences, in targeting advertisements to users, etc. In some embodiments, the value that the user obtains or anticipates obtaining from the use of the life-vertisement serves an encouragement to provide such information or otherwise cooperate.

In some embodiments, once imported, the object enhances the application experience for the user, and its usage statistics may be instrumented for use, for example, in assessing and optimizing campaign performance, including use in assessing or estimating brand lift metrics, which brand advertisers seek. In some embodiments, this form of brand feedback from consumers provides a source of potentially valuable data for assessing the brands strength and the impact of the campaign, among other uses.

In some embodiments, applications, or special applications, are designed or adapted to complement life-vertisement usage, and may be offered by an advertisement network. Users may be incentivized to participate or cooperate by value they expect or obtain from the application, the life-vertisements, or both. For instance, such an application could be or include a coupon basket where users can store life-vertisements including online coupons that allow users to save money in context, or advertisement baskets where users can clip and save life-vertisements for future reference or sharing, etc.

While the invention is described with reference to the above drawings, the drawings are intended to be illustrative, and the invention contemplates other embodiments within the spirit of the invention.

1. A method comprising:
using one or more computers, generating a first advertisement or use with or within at least one software-based application;
using one or more computers, facilitating providing an opportunity to a user to use the first advertisement with, or incorporate the first advertisement within, at least one software-based application;
using one or more computers, tracking use of the first advertisement by the user to obtain tracked usage information;
using one or more computers, based at least in part on the tracked usage information, determining advertisement performance information relating to performance of the first advertisement; and
using one or more computers, storing the advertisement performance information.

2. The method of claim 1, wherein interaction by the user with the first advertisement provides brand advertising value or brand engagement value to an advertiser.

3. The method of claim 1, comprising generating a first advertisement for use with or within at least one software-based application, wherein the first advertisement relates to a brand, and wherein the determined advertisement performance information is in relation to the brand.

4. The method of claim 1, wherein generating the first advertisement comprises generating an online advertisement.

5. The method of claim 1, comprising facilitating providing an opportunity to a user to use or incorporate the first advertisement, which can include using the first advertisement with, or incorporating the first advertisement within, at least one online application.

6. The method of claim 1, wherein determining advertisement performance in information relating to performance of the first advertisement comprises determining advertisement performance information relating to favorable branding value.

7. The method of claim 1, wherein determining advertisement performance information relating to performance of the first advertisement comprises determining advertisement performance information relating to brand engagement value.

8. The method of claim 1, comprising utilizing the advertisement performance information in assessing or optimizing advertising campaign performance.

9. The method of claim 1, wherein the first advertisement comprises an application object for use with or within a software-based application.

10. The method of claim 1, wherein usage of the first advertisement by the user is tracked over time and over usage of the advertisement with or within each of several software-based applications.

11. The method of claim 1, wherein the first advertisement is for use within a virtual reality-based game or simulation, and wherein the first advertisement comprises an object for importation into the virtual reality-based game or simulation.

12. The method of claim 1, wherein the first advertisement is for use with or within at least one software-based application at least in part as content.

13. The method of claim 1, wherein the first advertisement is for use with or within at least one software-based application at least in part as a promotion, discount, shopping incentive, or coupon.

14. The method of claim 1, wherein tracking use of the first advertisement by the user to obtain tracked usage information comprises tracking of a number of application importations and associated usage

15. The method of claim 1, comprising utilizing tracked performance information in targeting the user with one or more advertisements relating to a product, service or brand associated with the first advertisement.

16. A system comprising:
one or more server computers coupled to a network; and
one or more databases coupled to the one or more server computers;
wherein the one or more server computers are for:
using one or more computers, generating a first advertisement for use with or within at least one software-based application;
facilitating providing an opportunity to a user to use the first advertisement with, or incorporate the first advertisement within, at least one software-based application;
tracking use of the first advertisement by the user to obtain tracked usage information;
based at least in part on the tracked usage information, determining advertisement performance information relating to performance of the first advertisement; and
storing the advertisement performance information in at least one of the one or more databases.

17. The system of claim 16, wherein the first advertisement is associated with an advertisement campaign, and comprising tracking and storing advertisement campaign performance information.

18. The system of claim 1, facilitating providing an opportunity to a user to use the first advertisement with, or incorporate the first advertisement within, at least one software-based application adapted for use with advertisements including the first advertisement.

19. The system of claim 16, comprising generating a first advertisement for use with or within at least one software-based application, wherein the first advertisement relates to a brand, and wherein the determined advertisement performance information is in relation to the brand.

20. A computer readable medium or media containing instructions for executing a method comprising:
using one or more computers, generating a first advertisement for use with or within at least one online application, wherein the first advertisement relates to a brand;
using one or more computers, facilitating providing an opportunity to a user to elect to use the first advertisement with, or incorporate the first advertisement within, at least one online application;
using one or more computers, tracking use of the first advertisement by the user to obtain tracked usage information;
using one or more computers, based at least in part on the tracked usage information, determining advertisement performance information relating to performance of the first advertisement, wherein the determined advertisement performance information relates at least in part to favorable branding or brand engagement in relation to the brand;
using one or more computers, storing the advertisement performance information; and
using one or more computers, utilizing the advertisement performance information in assessing favorable branding value or brand engagement value associated with the first advertisement in relation to the brand.
